(19) United States
(12) Patent Application Publication
(10) Pub. No.: US 2026/0252747 A1
(43) Pub. Date: Aug. 27, 2026

(54) DESIGN SYSTEM, DESIGN METHOD, AND NON-TRANSITORY COMPUTER-READABLE STORAGE MEDIUM

(71) Applicant: NEC Corporation, Tokyo (JP)

(72) Inventor: Eiji MURAMATSU, Tokyo (JP)

(73) Assignee: NEC Corporation, Tokyo (JP)

(21) Appl. No.: 19/456,200

(22) Filed: Jan. 22, 2026

(30) Foreign Application Priority Data
Feb. 27, 2025 (JP) 2025-030413

(51) Int. Cl. G06F 30/12; G06F 111/20

(52) U.S. Cl. CPC G06F 30/12; G06F 2111/20

(57) ABSTRACT

A design system includes a configuration design means for receiving input of a system requirement and designing a specific system configuration that satisfies the input system requirement, by repeating concrete definition of system components constituting a system, a difference configuration extraction means for extracting a system component added or changed in one stage of concrete definition in a design process, an analysis means for determining whether the system component added or changed in one stage of concrete definition is related to the system requirement, and a requirement tracking configuration generation means for generating requirement tracking configuration information indicating a relationship between the system requirement and the system configuration, by using a determination result.

This application is based upon and claims the benefit of priority from Japanese Patent Application No. 2025-030413, filed on Feb. 27, 2025, the disclosure of which is incorporated herein in its entirety by reference.

### TECHNICAL FIELD

The present disclosure relates to a design system, a search device, a design method, a search method, and a program.

### BACKGROUND ART

A device or system may perform system design. For example, a system design device described in WO 2023/209994 A1 repeats application of a concrete-definition rule to a system configuration including an abstract component. Then, a concretely defined system configuration is output.

### SUMMARY

According to a first aspect of the present disclosure, a design system includes a configuration design means for receiving input of a system requirement and designing a specific system configuration that satisfies the input system requirement, by repeating concrete definition of system components constituting a system, a difference configuration extraction means for extracting a system component added or changed in one stage of concrete definition in a design process, an analysis means for determining whether the system component added or changed in one stage of concrete definition is related to the system requirement, and a requirement tracking configuration generation means for generating requirement tracking configuration information indicating a relationship between the system requirement and the system configuration, by using a determination result.

According to a second aspect of the present disclosure, a search device includes a requirement tracking information search means for receiving input of information for identifying a system configuration and a specific system requirement item and searching for requirement tracking configuration information of the system requirement item with respect to the system configuration, and a requirement tracking information combination means for, in a case of receiving a plurality of pieces of the requirement tracking configuration information for one system requirement item, consolidating the plurality of pieces of requirement tracking configuration information into one piece of requirement tracking configuration information.

According to a third aspect of the present disclosure, a design method includes a step of a computer receiving input of a system requirement and designing a specific system configuration that satisfies the input system requirement, by repeating concrete definition of system components constituting a system, a step of the computer extracting a system component added or changed in one stage of concrete definition in a design process, a step of the computer determining whether the component added or changed in one stage of concrete definition is related to the system requirement, and a step of the computer generating requirement tracking configuration information indicating a relationship between the system requirement and the system configuration, by using a determination result.

According to a fourth aspect of the present disclosure, a search method includes a step of a computer receiving input of information for identifying a system configuration and a specific system requirement item and searching for requirement tracking configuration information of the system requirement item with respect to the system configuration, and a step of, in a case of detecting a plurality of pieces of the requirement tracking configuration information for one system requirement item, the computer consolidating the plurality of pieces of requirement tracking configuration information into one piece of requirement tracking configuration information.

According to a fifth aspect of the present disclosure, a program causes a computer to execute processing of receiving input of a system requirement and designing a specific system configuration that satisfies the input system requirement, by repeating concrete definition of system components constituting a system, processing of extracting a system component added or changed in one stage of concrete definition in a design process, processing of determining whether the system component added or changed in one stage of concrete definition is related to the system requirement, and processing of generating requirement tracking configuration information indicating a relationship between the system requirement and the system configuration, by using a determination result.

According to a sixth aspect of the present disclosure, a program causes a computer to execute processing of receiving input of information for identifying a system configuration and a specific system requirement item and searching for requirement tracking configuration information of the system requirement item with respect to the system configuration, and processing of, in a case of detecting a plurality of pieces of the requirement tracking configuration information for one system requirement item, consolidating the plurality of pieces of requirement tracking configuration information into one piece of requirement tracking configuration information.

### BRIEF DESCRIPTION OF THE DRAWINGS

FIG. 1 is a block diagram illustrating a configuration example of a design system according to at least one example embodiment;

FIG. 2 is a diagram illustrating an example of a system configuration according to at least one example embodiment;

FIG. 3 is a diagram illustrating an example of a concrete-definition pattern according to at least one example embodiment;

FIG. 4 is a diagram illustrating an example of the concrete-definition pattern according to at least one example embodiment;

FIG. 5 is a diagram illustrating an example of the system configuration according to at least one example embodiment;

FIG. 6 is a diagram illustrating an example of update of requirement tracking configuration information according to at least one example embodiment;

FIG. 7 is a flowchart illustrating an operation example of the design system according to at least one example embodiment;

FIG. 8 is a diagram illustrating an example of difference configuration information according to at least one example embodiment;

FIG. 9 is a diagram illustrating an example of the difference configuration information according to at least one example embodiment;

FIG. 10 is a block diagram illustrating a configuration example of the design system according to at least one example embodiment;

FIG. 11 is a diagram illustrating an example of a requirement tracking configuration display screen displayed by an output device according to at least one example embodiment;

FIG. 12 is a flowchart illustrating an operation example of a search device according to at least one example embodiment;

FIG. 13 is a block diagram illustrating a configuration example of the design system according to at least one example embodiment;

FIG. 14 is a diagram illustrating another example of the requirement tracking configuration display screen displayed by the output device according to at least one example embodiment;

FIG. 15 is a flowchart illustrating an operation example of the design system according to at least one example embodiment;

FIG. 16 is a diagram illustrating an example of a configuration of the design system according to at least one example embodiment;

FIG. 17 is a diagram illustrating an example of a configuration of the search device according to at least one example embodiment;

FIG. 18 is a diagram illustrating an example of a procedure of processing in a design method according to at least one example embodiment;

FIG. 19 is a diagram illustrating an example of a procedure of processing in a search method according to at least one example embodiment; and

FIG. 20 is a diagram illustrating a hardware configuration of a computer that functions as a design device and the search device according to at least one example embodiment.

### EXAMPLE EMBODIMENT

Hereinafter, example embodiments of the present disclosure will be described. However, the present disclosure is not limited to each example embodiment exemplified below, and various modifications can be made within a scope described in the claims. For example, example embodiments obtained by appropriately combining techniques (some or all of things or methods) adopted in the example embodiments exemplified below can also be included in the scope of the present disclosure. Example embodiments obtained by appropriately omitting some of the techniques adopted in the example embodiments exemplified below can also be included in the scope of the present disclosure. The effects mentioned in the example embodiments exemplified below are examples of effects expected in the example embodiments, and do not define the extension of the present disclosure. In other words, example embodiments that do not provide the effects mentioned in the example embodiments exemplified below can also be included in the scope of the present disclosure.

### First example embodiment

A first example embodiment that is an example of the example embodiments of the present disclosure will be described in detail with reference to the drawings. The present example embodiment is a basic form of the individual example embodiments to be described below. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Description of configuration

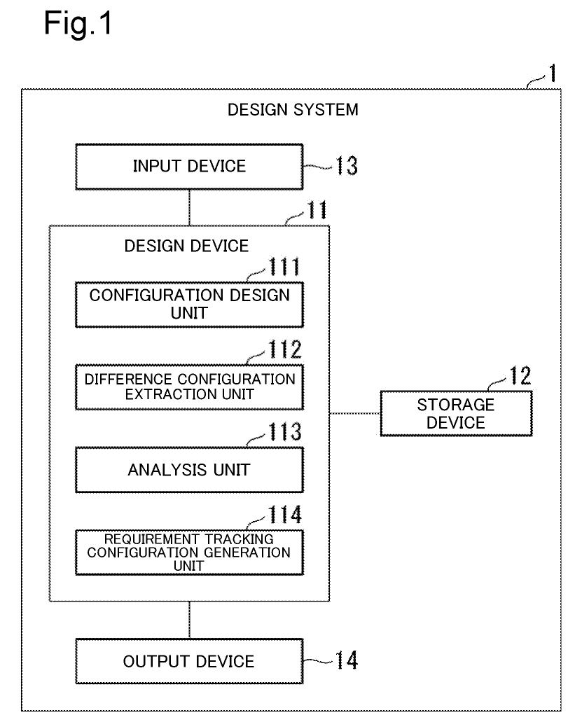

FIG. 1 is a block diagram illustrating an example of a configuration of a design system according to at least one example embodiment.

As illustrated in FIG. 1, a design system 1 includes a design device 11, a storage device 12, an input device 13, and an output device 14. The design device 11 and the storage device 12 are communicably connected. For example, each of a configuration design unit 111, a difference configuration extraction unit 112, an analysis unit 113, and a requirement tracking configuration generation unit 114 may be able to access the storage device 12. The design device 11 and the input device 13 are also communicably connected. The design device 11 and the output device 14 are also communicably connected. The design device 11 includes the configuration design unit 111, the difference configuration extraction unit 112, the analysis unit 113, and the requirement tracking configuration generation unit 114.

The design device 11 performs system design. The design device 11 or a part thereof may be configured using, for example, a computer such as a workstation (WS) or a personal computer (PC). Alternatively, the design device 11 or a part thereof may be configured using an application specific integrated circuit (ASIC) or a field programmable gate array (FPGA).

The storage device 12 stores various types of data to be processed by the design device 11.

The input device 13 acquires input data. In particular, the input device 13 acquires information indicating a requirement (system requirement) of a system to be designed by the design device 11. The input device 13 may include, for example, an input device such as a keyboard and a mouse, and may receive a user operation for inputting data. The input device 13 may communicate with an external device of the design system 1 to receive input data. The input device 13 outputs the acquired input data to the design device 11.

The output device 14 outputs data. A method by which the output device 14 outputs data is not limited to a specific method. For example, the output device 14 may be configured using a display device, and various images may be displayed under the control of the design device 11.

The design device 11, the storage device 12, the input device 13, and the output device 14, or some thereof may be configured as one device. For example, the design device 11, the storage device 12, the input device 13, and the output device 14 may be incorporated in an integrated computer system such as a laptop computer.

The input device 13, the output device 14, or both of them may be external configurations of the design system 1.

The configuration design unit 111 receives input of the system requirement from the input device 13, and automatically designs a specific system configuration that satisfies the input system requirement. The configuration design unit 111 designs a system including components to be parts constituting the system.

The configuration design unit 111 corresponds to an example of the configuration design means.

The system requirement is a requirement that the system to be designed is to satisfy. Here, the system requirement includes an abstract system configuration. The system requirement may include one or more constraint conditions to be satisfied by the system to be designed, in addition to the abstract system configuration.

A component that is associated with a specific device or system and does not require further concrete definition is also referred to as a concretely defined component or a specific component. A component other than the concretely defined component, that is, a component that requires further concrete definition in system design is also referred to as an abstract component.

The configuration design unit 111 is assumed to know whether a certain component corresponds to an abstract component or a concretely defined component. For example, a concrete-definition pattern used by the configuration design unit 111 for system design may include information for distinguishing between an abstract component and a concretely defined component. Alternatively, the storage device 12 may store, for each component, information indicating whether the component is an abstract component or a concretely defined component.

In a case where all the components included in a system configuration are concretely defined components, the system configuration is also referred to as a concretely defined system configuration or a specific system configuration.

A system configuration including an abstract component is also referred to as an abstract system configuration.

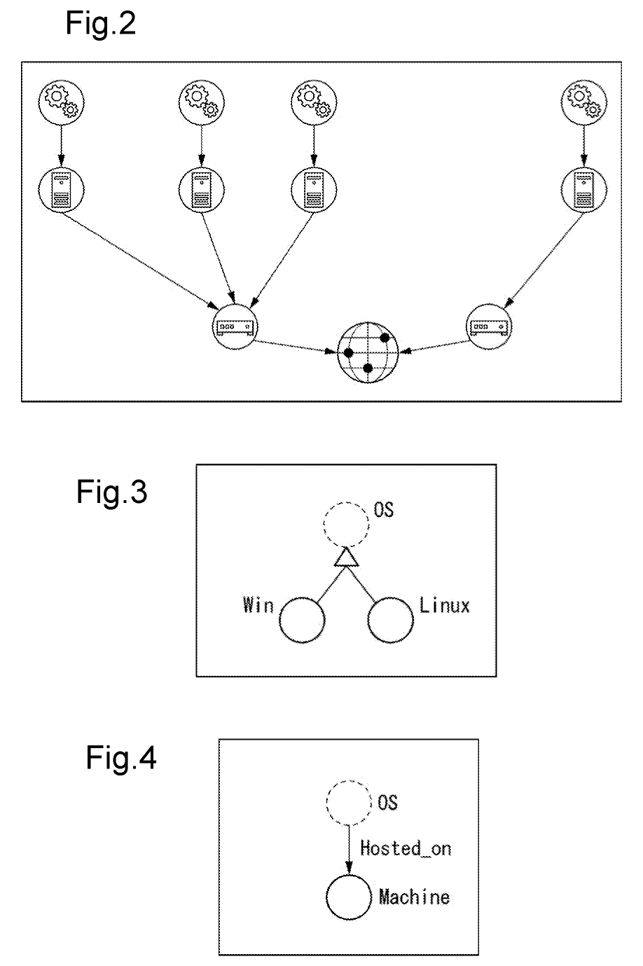

FIG. 2 is a diagram illustrating an example of the system configuration.

The system configuration illustrated in FIG. 2 includes a plurality of components indicated by circles, and the components have relationships indicated by arrows. Since FIG. 2 illustrates an image of the system configuration, description of each component and types of relationships is omitted.

The configuration design unit 111 designs the system by adding or substituting components in accordance with a concrete-definition pattern. The concrete-definition pattern defines a component that can be added to or substituted for a specific component. The concrete-definition pattern may include a relationship between components.

FIG. 3 is a diagram illustrating an example of the concrete-definition pattern.

For example, the concrete-definition pattern illustrated in FIG. 3 indicates a concrete-definition pattern in which components of an “OS” (Operating System) are substituted with components of “Win” or “Linux” (Linux is a registered trademark).

FIG. 4 is a diagram illustrating another example of the concrete-definition pattern.

The concrete-definition pattern illustrated in FIG. 4 indicates a concrete-definition pattern in which components of “Machine” are added to the components of “OS” and a relationship of “Hosted_on” is added.

The concrete-definition pattern may be stored in the storage device 12.

The configuration design unit 111 performs the above-described system design in stages. That is, processing of concretizing a specific component that has not been concretely defined among components included in an initial or intermediate system configuration is repeated until completion of concrete definition of all the components. The completion of concrete definition of the components mentioned herein means that the components become specific components.

The configuration design unit 111 stores the system configuration in the storage device 12 for each stage of system design. For example, the storage device 12 may store a system requirement having been input. Then, the configuration design unit 111 may store the obtained system configuration in the storage device 12 every time the system design is performed in one stage, that is, every time the concrete-definition pattern is applied to the components included in the system configuration.

The configuration design unit 111 determines whether the system configuration to which the concrete-definition pattern is applied satisfies a constraint condition imposed on the system configuration. The number of constraint conditions imposed on the system configuration is not limited to a specific number. In a case where there are one or more constraint conditions that are not satisfied, the configuration design unit 111 rejects the system configuration to which the concrete-definition pattern has been applied, and applies another concrete-definition pattern. The constraint condition is a condition to be satisfied by the system configuration, and may be stored in the storage device 12.

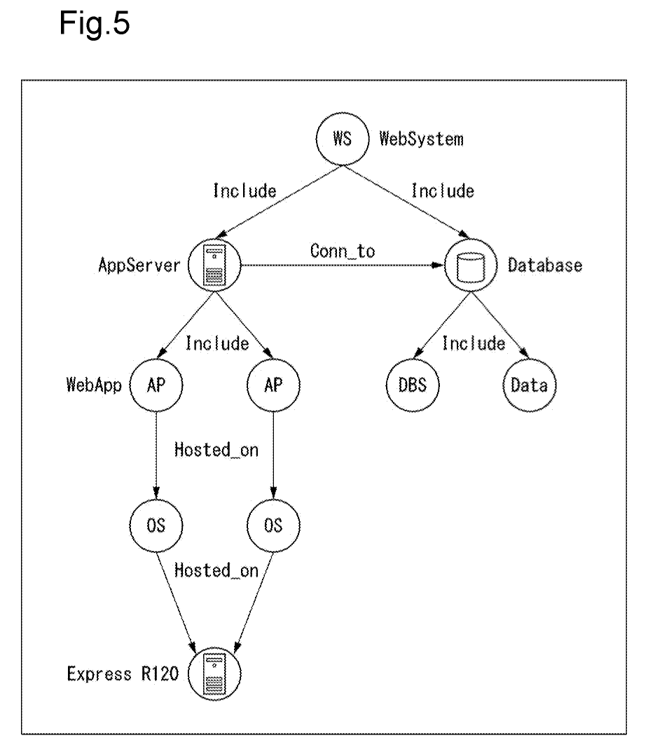

FIG. 5 is a diagram illustrating an example of the system configuration. The system configuration illustrated in FIG. 5 includes components such as “WebSystem” (web system), “AppServer” (application server), “Database” (database), “Web App” (web application), “OS” (OS), “ExpressR120” (physical server ExpressR120), “DBS” (database system), and “Data” (data). The components have relationships such as “Include” (include), “Conn_to” (connect), and “Hosted_on” (hosted).

The configuration design unit 111 stores, in the storage device 12, configuration information indicating the system configuration and outputs the configuration information to the difference configuration extraction unit 112.

The difference configuration extraction unit 112 extracts system components concretely defined by the configuration design unit 111 in one stage. The difference configuration extraction unit 112 acquires, from the storage device 12, a system configuration before the system configuration input from the configuration design unit 111 is concretely defined in one stage, and compares components between the system configurations before and after the system configuration is concretely defined in one stage.

The difference configuration extraction unit 112 corresponds to an example of the difference configuration extraction means.

The difference configuration extraction unit 112 compares the components between the system configurations to extract a component that is a difference between system configurations, a component with which the component has a relationship, and information regarding the relationship. The extracted information is information indicating that the configuration design unit 111 has performed design by applying a concrete-definition pattern to a component having a relationship with the component extracted as a difference between the compared system configurations. Hereinafter, the component extracted as the difference is referred to as an “additional component”, and the component having the relationship with the additional component is referred to as a “concrete-definition target component”.

The difference configuration extraction unit 112 outputs, to the analysis unit 113, difference configuration information including the concrete-definition target component, the additional component, and the relationship between components.

The analysis unit 113 analyzes whether the additional component is related to the system requirement. That is, the analysis unit 113 determines whether the additional component is related to the system requirement. Specific analysis contents will be described later. The analysis unit 113 analyzes whether the additional component is related to the system requirement for each single requirement item included in the system requirement.

The analysis unit 113 corresponds to an example of the analysis means.

The requirement item mentioned herein is an item of a characteristic required for a system, a partial system, or a component. The partial system mentioned herein is a part of the system.

For example, “minimum throughput” or “maximum number of users” corresponds to an example of a certain requirement item. However, the “minimum throughput” and the “maximum number of users” are examples, and the requirement item is not limited to a specific item.

The characteristic possessed by the system, the partial system, or the component is also referred to as an attribute possessed by the system, the partial system, or the component. For example, the minimum throughput of a certain component or the maximum number of users of a certain component (a maximum value of the number of users that can be supported by the component) corresponds to an example of the attribute possessed by the certain component. However, the items such as the minimum throughput and the maximum number of users are examples, and a target item of the attribute is not limited to a specific item.

The characteristic required for the system, the partial system, or the component is also referred to as an attribute required for the system, the partial system, or the component. The attribute required for the system, the partial system, or the component may be a characteristic indicated in the system requirement or a characteristic calculated from the characteristic indicated in the system requirement.

For example, in a case where the maximum number of users required in the system requirement is 100, and the maximum number of users is equally shared by two components, the maximum number of users required for one component is calculated to be 50.

The attribute possessed by the system, the partial system, or the component and the attribute required for the system, the partial system, or the component are also collectively referred to as an attribute of the system, the partial system, or the component.

The target item of the attribute is also referred to as an item of the attribute or an attribute item. The item of the attribute required for the system, the partial system, or the component can also be referred to as a requirement item of the system, the partial system, or the component.

Information indicating an attribute is also referred to as attribute information.

The analysis unit 113 acquires, from the storage device 12, requirement tracking configuration information stored by the requirement tracking configuration generation unit 114 to be described later. A requirement tracking configuration mentioned herein is a configuration of a part related to a certain requirement item (for example, a requirement item designated by the user) in the configuration of the system (which may be a system in the middle of design). The requirement tracking configuration can be regarded as a partial configuration obtained by extracting, from the system configuration, only a component related to a certain requirement item and a relationship (relationship between components) related to the requirement item.

The requirement tracking configuration information is information indicating the requirement tracking configuration. The requirement tracking configuration information indicates a configuration of the requirement tracking configuration and an attribute of a component of the requirement tracking configuration.

The analysis unit 113 extracts, from the requirement tracking configuration information or the difference configuration information, an attribute of the concrete-definition target component (here, an attribute possessed by the concrete-definition target component) related to the requirement item included in the system requirement. The requirement item included in the system requirement is also referred to as a system requirement item. There may be a plurality of attributes related to a single requirement item.

The analysis unit 113 determines whether a constraint condition using the extracted attribute is included in a constraint condition of the additional component. That is, the analysis unit 113 determines whether the extracted attribute is used for the constraint condition of the additional component.

For example, in a case where a throughput is extracted as the attribute, the analysis unit 113 determines whether a constraint condition using (attribute information of) a throughput of the additional component is included in the constraint condition of the additional component.

In a case where it is determined that the constraint condition using the attribute is included, the analysis unit 113 generates, for each single requirement item, analysis result information including the extracted difference configuration information and attribute information regarding the attribute of the additional component.

The analysis unit 113 determines whether the constraint condition using the extracted attribute is included in the constraint condition of the concrete-definition target component. That is, the analysis unit 113 determines whether the extracted attribute is used for the constraint condition of the concrete-definition target component.

In a case where it is determined that the constraint condition using the attribute is included, the analysis unit 113 generates, for each single requirement item, analysis result information including the extracted difference configuration information and attribute information regarding the attribute of the concrete-definition target component.

The analysis unit 113 determines whether the constraint condition using the extracted attribute is included in a constraint condition of a relationship between the additional component and the concrete-definition target component. That is, the analysis unit 113 determines whether the extracted attribute is used for the constraint condition of the relationship.

In a case where it is determined that the constraint condition using the attribute is included, the analysis unit 113 generates, for each single requirement item, analysis result information including the extracted difference configuration information and attribute information regarding the attribute of the relationship.

The analysis unit 113 outputs the generated analysis result information to the requirement tracking configuration generation unit 114.

The requirement tracking configuration generation unit 114 generates the requirement tracking configuration information for each system requirement item by using the analysis result information (a determination result by the analysis unit 113). The requirement tracking configuration generation unit 114 generates a requirement tracking configuration for each single requirement item included in the system requirement.

The requirement tracking configuration generation unit 114 corresponds to an example of the requirement tracking configuration generation means.

For each single requirement item included in the system requirement, the requirement tracking configuration generation unit 114 acquires, from the storage device 12, the requirement tracking configuration information before being concretely defined in one stage and the analysis result information input by the analysis unit 113.

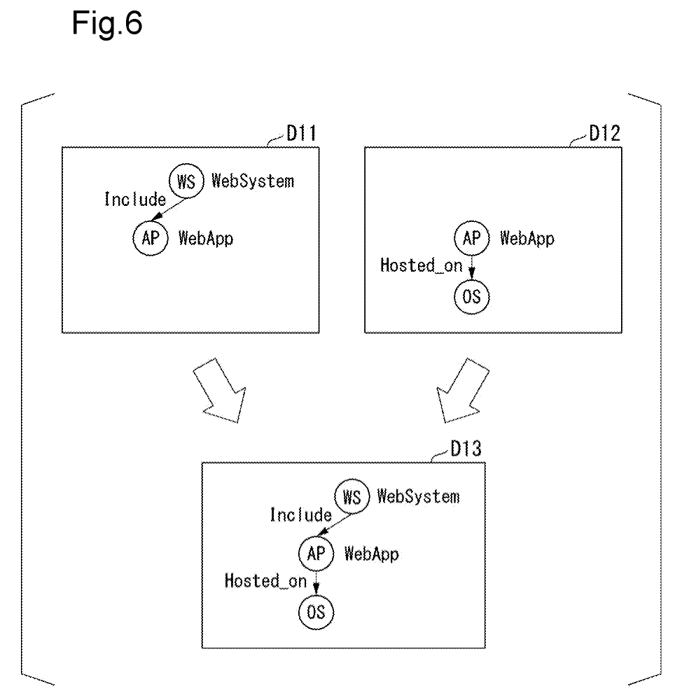

FIG. 6 is a diagram illustrating an example of updating the requirement tracking configuration information.

As illustrated in FIG. 6, for each single requirement item, the requirement tracking configuration generation unit 114 integrates the requirement tracking configuration information and the analysis result information to update the requirement tracking configuration information, and stores the updated requirement tracking configuration information in the storage device 12. In the example of FIG. 6, “Web App” (web application), which is a component of a system configuration D11 included in the requirement tracking configuration information one stage before, and “Web App” (web application), which is a component of a system configuration D12 included in the analysis result information match. Therefore, the requirement tracking configuration generation unit 114 combines the system configuration D11 included in the requirement tracking configuration information one stage before and the system configuration D12 included in the analysis result information in such a way as to be connected by a part of the component of “Web App”. As a result, the requirement tracking configuration generation unit 114 generates a system configuration D13 included in the updated requirement tracking configuration information.

The requirement tracking configuration generation unit 114 generates the requirement tracking configuration information as in the example of FIG. 6, so that the user can easily grasp a related component for each single requirement item included in the system requirement.

### Description of operation

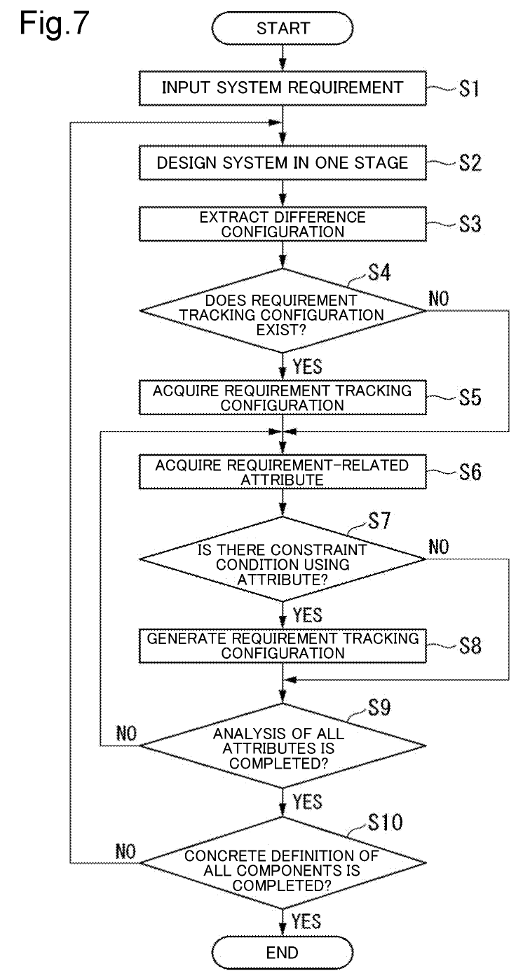

FIG. 7 is a flowchart illustrating an example of an operation of the design system 1.

### Step S1

The configuration design unit 111 receives input of a system requirement from the input device 13.

After step S1, the processing proceeds to step S2.

### Step S2

The configuration design unit 111 adds or substitutes a component in accordance with a concrete-definition pattern to design a specific system configuration that satisfies the input system requirement and a constraint condition in one stage. The configuration design unit 111 stores the designed system configuration in the storage device 12 and outputs the system configuration to the difference configuration extraction unit 112.

After step S2, the processing proceeds to step S3.

### Step S3

When receiving input of the system configuration from the configuration design unit 111, the difference configuration extraction unit 112 generates a difference configuration information including a difference in components from the system configuration before one-stage design acquired from the storage device 12. The difference configuration extraction unit 112 outputs the generated difference configuration information to the analysis unit 113.

After step S3, the processing proceeds to step S4.

### Step S4

When receiving input of the difference configuration information from the difference configuration extraction unit 112, the analysis unit 113 determines whether the requirement tracking configuration information exists in the storage device 12.

In a case where the analysis unit 113 determines that the requirement tracking configuration information exists (step S4: YES), the processing proceeds to step S5.

On the other hand, in a case where the analysis unit 113 determines that the requirement tracking configuration information does not exist (step S4: NO), the processing proceeds to step S6.

### Step S5

The analysis unit 113 acquires the requirement tracking configuration information from the storage device 12.

After step S5, the processing proceeds to step S6.

### Step S6

The analysis unit 113 acquires, from the requirement tracking configuration information or the difference configuration information, an attribute of a concrete-definition target component related to the requirement item included in the system requirement.

After step S6, the processing proceeds to step S7.

### Step S7

The analysis unit 113 determines whether the constraint condition using the extracted attribute is included in a constraint condition of an additional component, a constraint condition of the concrete-definition target component, and a constraint condition of a relationship between the additional component and the concrete-definition target component (step S7).

In a case where it is determined that the constraint condition using the extracted attribute is included (step S7: YES), for each single requirement item, the analysis unit 113 outputs, as analysis result information, the extracted difference configuration information and attribute information (attribute information regarding the extracted attribute) included in the constraint condition to the requirement tracking configuration generation unit 114. Thereafter, the processing proceeds to step S8.

On the other hand, in a case where the analysis unit 113 determines that the constraint condition using the extracted attribute is not included (step S7: NO), the processing proceeds to step S9.

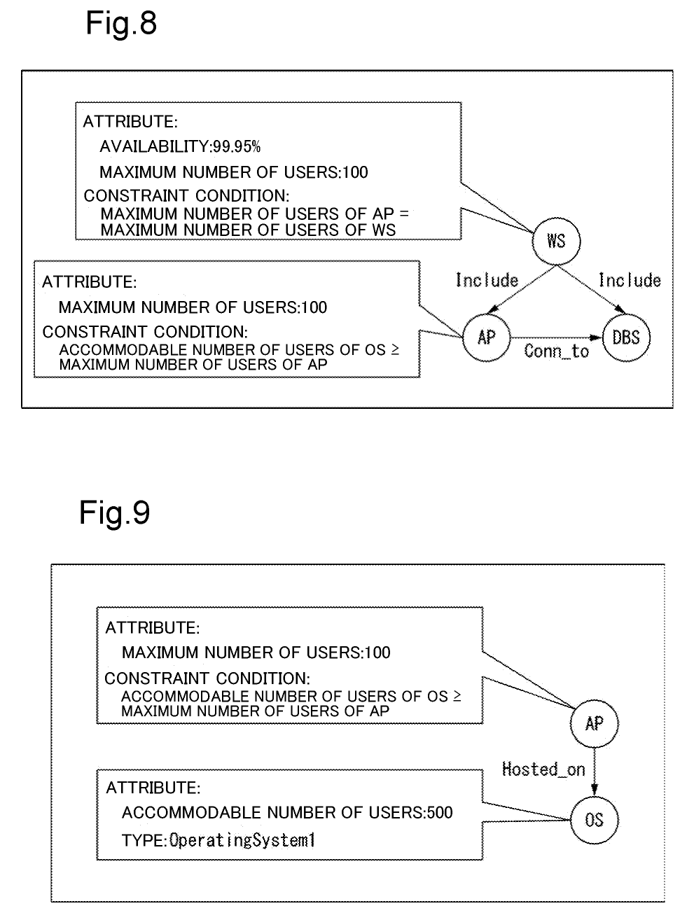

An image of the difference configuration information is illustrated in FIGS. 8 and 9.

FIG. 8 is a diagram illustrating an example of the difference configuration information. In the difference configuration information illustrated in FIG. 8, the concrete-definition target component “WS” (web system) and the additional components “AP” (web application) and “DBS” (database system) have relationships indicated by arrows, and the components “WS” (web system) and “AP” (web application) have attributes and constraint conditions indicated by balloons.

In the example of FIG. 8, in step S6, the analysis unit 113 extracts “maximum number of users” of the concrete-definition target component “WS” (web system) as the attribute related to the requirement item included in the system requirement. Next, in step S7, the analysis unit 113 determines that the constraint condition using the attribute “maximum number of users” of the concrete-definition target component “WS” (web system) is included in the constraint condition (“maximum number of users of AP = maximum number of users of WS”) of the “WS” (web system), and adds the attribute “maximum number of users” of the additional component “AP” (web application) to the analysis result information.

FIG. 9 is a diagram illustrating another example of the difference configuration information. In the difference configuration information illustrated in FIG. 9, the concrete-definition target component “AP” (web application) and the additional component “OS” (OS) have a relationship indicated by an arrow, and the components “AP” (web application) and “OS” (OS) have attributes and constraint conditions indicated by balloons.

In the example of FIG. 9, in step S6, the analysis unit 113 extracts “maximum number of users” of the concrete-definition target component “AP” (web application) as the attribute related to the requirement item included in the system requirement. Next, in step S7, the analysis unit 113 determines that the constraint condition using the attribute “maximum number of users” of the concrete-definition target component “AP” (web application) is included in the constraint condition of “AP” (web application) (“accommodable number of users of OS ≥ maximum number of users of AP”), and adds the attribute “accommodable number of users” of the additional component “OS” (OS) to the analysis result information.

### Step S8

When receiving input of the analysis result information from the analysis unit 113, the requirement tracking configuration generation unit 114 acquires, from the storage device 12, the requirement tracking configuration information before being concretely defined in one stage, generates the requirement tracking configuration information by integrating the requirement tracking configuration information and the analysis result information, and stores the requirement tracking configuration information in the storage device 12. The requirement tracking configuration generation unit 114 notifies the analysis unit 113 that the requirement tracking configuration generation step has been completed.

After step S8, the processing proceeds to step S9.

### Step S9

The analysis unit 113 determines whether analysis for all the attributes acquired in step S6 has been completed.

In a case where the analysis unit 113 determines that there is an attribute for which analysis is not completed (step S9: NO), the processing returns to step S6. In this case, the analysis unit 113 executes the processing of step S6 on the incomplete attribute.

On the other hand, in a case where it is determined that the analysis for all the attributes has been completed (step S9: YES), the analysis unit 113 notifies the configuration design unit 111 that the analysis step has been completed. Thereafter, the processing proceeds to step S10.

### Step S10

The configuration design unit 111 determines whether concrete definition of all the components has been completed.

In a case where the configuration design unit 111 determines that there is a component for which the concrete definition has not been completed (step S10: NO), the processing returns to step S2. In this case, the configuration design unit 111 executes the processing of step S2 on the incomplete component.

On the other hand, in a case where the configuration design unit 111 determines that the concrete definition of all the components has been completed, the design system 1 ends the processing of FIG. 7.

### Description of Effect

As described above, the configuration design unit 111 receives the input of the system requirement, and designs a specific system configuration that satisfies the input system requirement, by repeating concrete definition of the system components constituting the system.

The difference configuration extraction unit 112 extracts a system component added or changed in one stage of concrete definition in the design process.

The analysis unit 113 determines whether the system component added or changed in one stage of concrete definition is related to the system requirement.

The requirement tracking configuration generation unit 114 generates requirement tracking configuration information indicating a relationship between the system requirement and the system configuration, by using a determination result.

The design system 1 outputs the requirement tracking configuration information indicating the relationship between the system requirement and the system configuration that is a design result. The user of the design system 1 can grasp the relationship between the system requirement and the system configuration that is the design result, by referring to the requirement tracking configuration information.

### Second example embodiment

### Description of configuration

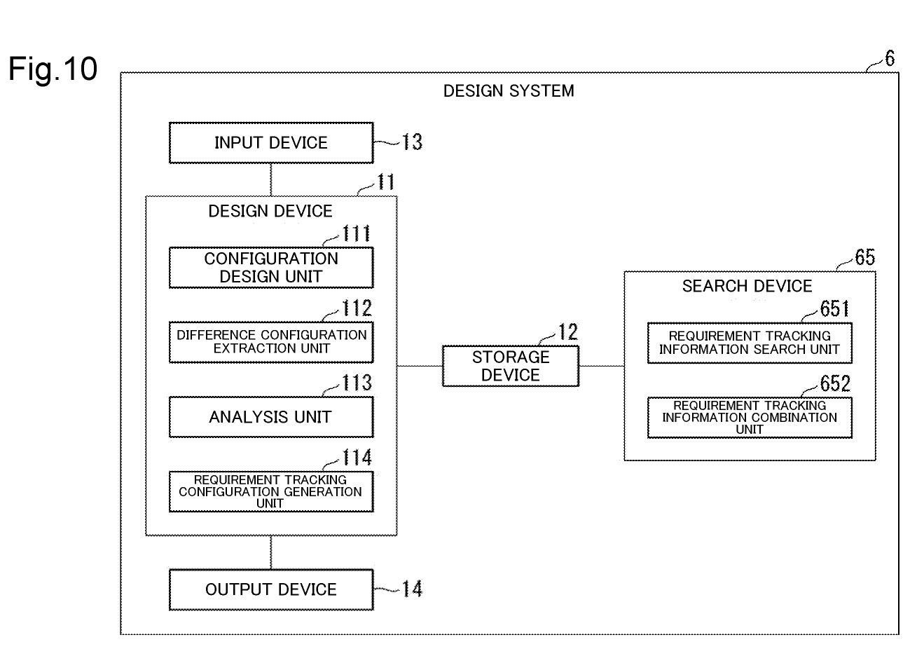

FIG. 10 is a block diagram illustrating another example of the configuration of the design system according to at least one example embodiment. As illustrated in FIG. 10, a design system 6 according to a second example embodiment for carrying out the present disclosure further includes a search device 65 in addition to each unit included in the design system 1. In other respects, the design system 6 is similar to the design system 1. In the units of FIG. 10, units having similar functions to those of the units of FIG. 1 are denoted by the same reference numerals (1, 11, 12, 13, 14, 111, 112, 113, 114), and a detailed description thereof will be omitted here.

The search device 65 and the storage device 12 are communicably connected. For example, a requirement tracking information search unit 651 may be able to access the storage device 12.

An application range of each technique adopted in the present example embodiment is not limited to the present example embodiment.

That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

The search device 65 includes the requirement tracking information search unit 651 and a requirement tracking information combination unit 652.

The requirement tracking information search unit 651 is connected to the storage device 12.

The requirement tracking information search unit 651 receives, from the input device 13, input of information for identifying the system configuration and the system requirement item, and searches for the requirement tracking configuration information of the input requirement item with respect to the identified system configuration.

The requirement tracking information search unit 651 corresponds to an example of the requirement tracking information search means.

Here, the storage device 12 stores a plurality of system requirements and a system configuration for each system requirement. The requirement tracking information search unit 651 extracts the requirement tracking configuration information from the system configuration identified by the information for identifying the system configuration among a plurality of system configurations stored in the storage device 12.

Alternatively, the requirement tracking information search unit 651 may receive input of the system requirement item from the input device 13 and search, from the entire system configuration stored in the storage device 12, for the requirement tracking configuration information of the input requirement item.

There may be a plurality of system requirement items to be input. The requirement tracking information search unit 651 acquires, from the storage device 12, the requirement tracking configuration information relevant to the received system configuration and requirement item by the above search, and outputs the requirement tracking configuration information to the requirement tracking information combination unit 652.

In a case of receiving a plurality of pieces of the requirement tracking configuration information from the requirement tracking information search unit 651, the requirement tracking information combination unit 652 combines the plurality of pieces of the requirement tracking configuration information. Specifically, the requirement tracking information combination unit 652 compares the components of the system configuration and the attributes of the components included in the requirement tracking configuration information for the plurality of pieces of requirement tracking configuration information. Then, the requirement tracking information combination unit 652 generates a single piece of requirement tracking configuration information including all the components and attributes included in the plurality of pieces of requirement tracking configuration information, and outputs the single piece of requirement tracking configuration information to the output device 14. The combination of the requirement tracking configuration information performed by the requirement tracking information combination unit 652 can be regarded as consolidating a plurality of pieces of requirement tracking configuration information into one piece of requirement tracking configuration information.

The requirement tracking information combination unit 652 corresponds to an example of the requirement tracking information combination means.

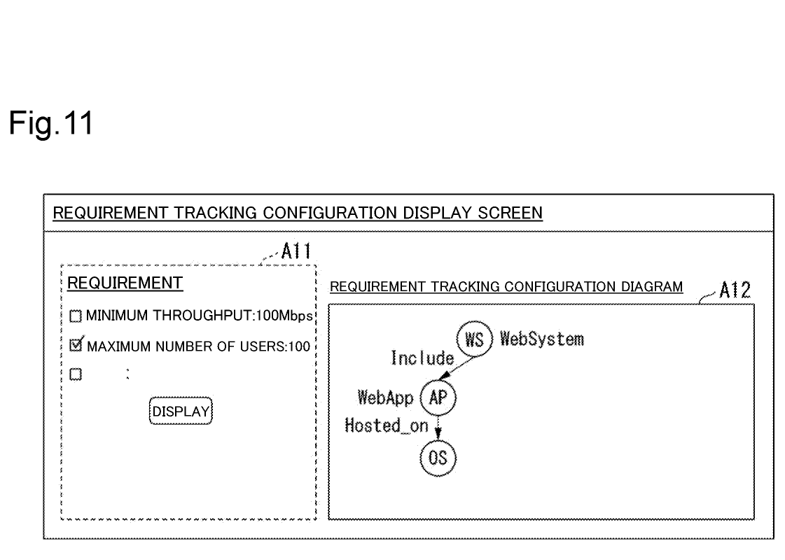

FIG. 11 is a diagram illustrating an example of a requirement tracking configuration display screen displayed by the output device 14.

The output device 14 may output (display) the requirement tracking configuration display screen as illustrated in FIG. 11. In the example of FIG. 11, the requirement tracking configuration screen includes a display area A11 of system requirement information and a display area A12 of a requirement tracking configuration diagram. The system requirement information illustrated in the display area A11 indicates a requirement item and a specific value of the requirement item included in the system requirement input from the input device 13. The requirement tracking configuration diagram illustrated in the display area A12 illustrates the requirement tracking configuration information of the requirement item selected in the display area A11 of the system requirement information. In the example of FIG. 11, the requirement item “maximum number of users” included in the system requirement information is selected, and the requirement tracking configuration information of the requirement item “maximum number of users” is displayed in the display area A12 in the requirement tracking configuration diagram.

As described above, the information for identifying the system configuration and the system requirement item may be input from the input device 13. In this case, the requirement tracking configuration display screen displayed by the output device 14 may be provided with a display area of information (for example, a system configuration name or an identification number of a system configuration) for identifying the system configuration, in addition to the display area A11 of the system requirement information.

The output device 14 may display, in the display area A12, a system configuration diagram indicating specific system configuration information satisfying the system requirement input from the input device 13 and a requirement tracking configuration diagram indicating the requirement tracking configuration information side by side. The output device 14 may display, in the display area A12, the system configuration diagram indicating specific system configuration information satisfying the system requirement input from the input device 13 and the requirement tracking configuration diagram indicating the requirement tracking configuration information in an overlapping manner. In a case where the output device 14 displays the system configuration information and the requirement tracking configuration information in an overlapping manner, the requirement tracking configuration information may be highlighted. This can facilitate confirmation of the requirement tracking configuration information by the user.

### Description of operation

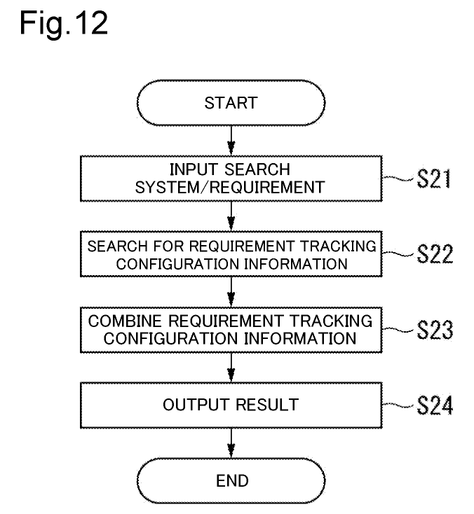

FIG. 12 is a flowchart illustrating an example of the operation of the search device 65.

In the processing of FIG. 12, the requirement tracking information search unit 651 receives, from the input device 13, input of the information for identifying the system configuration and the specific system requirement item (step S21).

Next, the requirement tracking information search unit 651 acquires, from the storage device 12, the requirement tracking configuration information of the input system requirement item for the system configuration identified by the information from the input device 13, and outputs the requirement tracking configuration information to the requirement tracking information combination unit 652 (step S22).

Next, the requirement tracking information combination unit 652 combines one or more pieces of the requirement tracking configuration information input from the requirement tracking information search unit 651 to generate a single piece of requirement tracking configuration information (step S23).

Next, the requirement tracking information combination unit 652 outputs the generated single piece of requirement tracking configuration information via the output device 14 (step S24).

After step S24, the search device 65 ends the processing of FIG. 12.

### Description of Effect

As described above, the requirement tracking information search unit 651 receives the input of the information for identifying the system configuration and the specific system requirement item, and searches for the requirement tracking configuration information of the system requirement item with respect to the system configuration.

In a case of receiving a plurality of pieces of the requirement tracking configuration information, the requirement tracking information combination unit 652 combines the requirement tracking configuration information.

According to the design system 6, the user of the design system 6 can search for specific requirement tracking configuration information by designating the system configuration and the requirement item. The requirement items may be single or plural, and it is possible to grasp the relationship between the system requirement that the user wants to confirm and the system configuration that is the design result.

### Third example embodiment

### Description of configuration

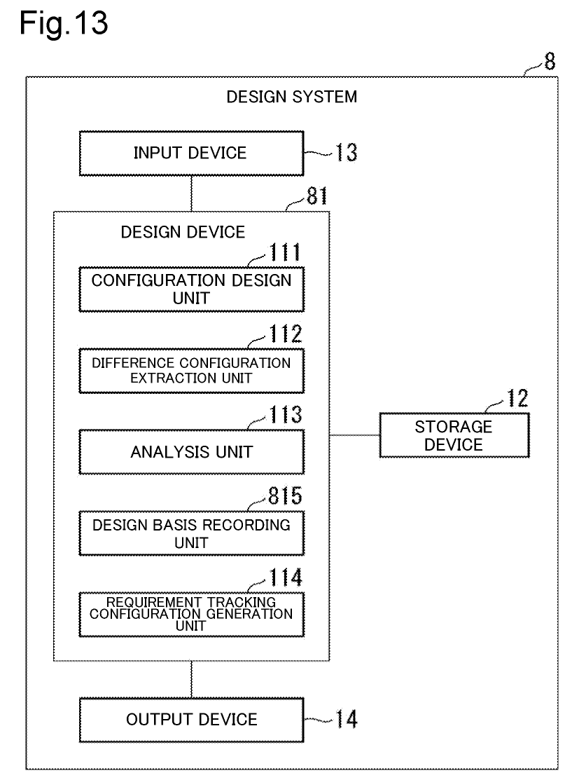

FIG. 13 is a block diagram illustrating another configuration of the design system according to at least one example embodiment. As illustrated in FIG. 13, in a design system 8 according to a third example embodiment for carrying out the present disclosure, a design device 81 is different from the design device 11 of the design system 1. The design device 81 further includes a design basis recording unit 815 in addition to each unit included in the design device 11. In other respects, the design system 8 is similar to the design system 1. In the units of FIG. 13, units having similar functions to those of the units of FIG. 1 are denoted by the same reference numerals, and a detailed description thereof will be omitted here.

The design device 81 and the storage device 12 are communicably connected. For example, each of the configuration design unit 111, the difference configuration extraction unit 112, the analysis unit 113, the design basis recording unit 815, and the requirement tracking configuration generation unit 114 may be able to access the storage device 12. The design device 81 and the input device 13 are also communicably connected. The design device 81 and the output device 14 are also communicably connected.

An application range of each technique adopted in the present example embodiment is not limited to the present example embodiment.

That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

The design device 81 includes the configuration design unit 111, the difference configuration extraction unit 112, the analysis unit 113, the design basis recording unit 815, and the requirement tracking configuration generation unit 114. The design basis recording unit 815 is connected to the storage device 12.

The design basis recording unit 815 adds design basis information to the analysis result information generated by the analysis unit 113. The design basis information is information indicating that the designed system satisfies a required constraint condition. As the design basis information, for example, an evaluation content using an identification name, a feature, or an attribute of a component such as a concrete-definition target component, an additional component, or a configuration selected as a result of concrete definition can be used. Here, the identification name is a name for identifying a component. The constraint condition may be expressed using a mathematical expression. That is, the evaluation content using the attribute may be represented by an equation or an inequality using the attribute, or a combination thereof. This design basis information is information indicating what constraint condition exists between components for a specific attribute and what configuration is selected as a result of concrete definition, and is information that allows the user to grasp a design basis.

The design basis recording unit 815 corresponds to an example of the design basis recording means.

The design basis recording unit 815 receives input of the analysis result information from the analysis unit 113, and extracts the design basis information from the constraint condition of the additional component, the constraint condition of the concrete-definition target component, and the constraint condition of the relationship between the additional component and the concrete-definition target component.

The design basis recording unit 815 may extract a specific value of the attribute from one or more of the additional component, the concrete-definition target component, or the attribute of the relationship between the additional component and the concrete-definition target component, and add the extracted value to the design basis information.

The design basis recording unit 815 adds the design basis information to the analysis result information, and outputs the added information to the analysis unit 113.

The design basis recording unit 815 may determine whether to add the design basis information to the analysis result information, according to a type of the evaluation content using the attribute. For example, the design basis recording unit 815 may not add the design basis information to the analysis result information in a case where the evaluation content using the attribute is an equation, and may add the design basis information to the analysis result information in a case where the evaluation content is an inequality.

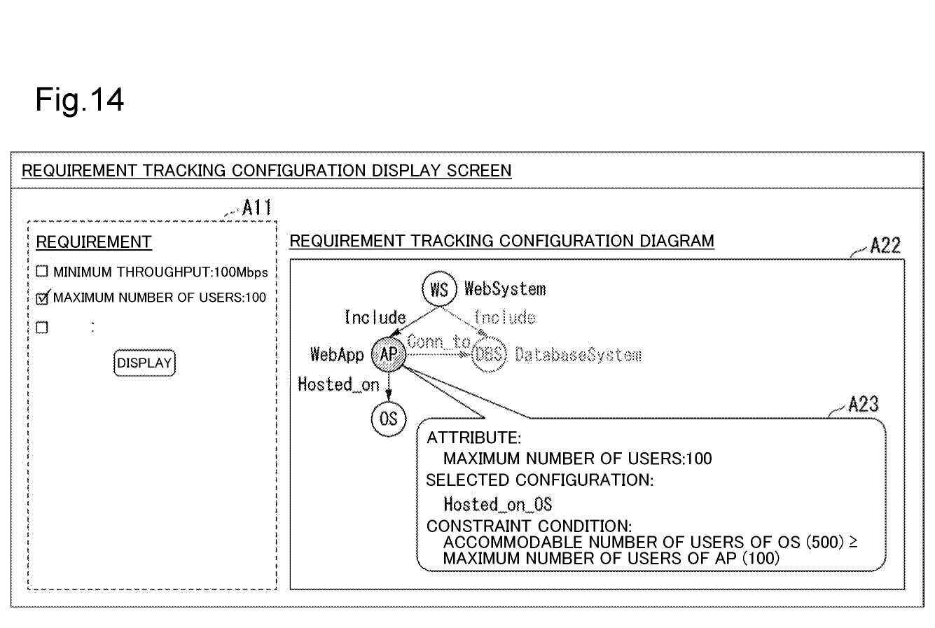

FIG. 14 is a diagram illustrating another example of the requirement tracking configuration display screen displayed by the output device 14.

The output device 14 may output (display) the requirement tracking configuration screen as illustrated in FIG. 14. The requirement tracking configuration screen in the example of FIG. 14 is different from the example of FIG. 11 in that a display area A22 of the requirement tracking configuration diagram includes a display area A23 of design basis information. In other respects, the requirement tracking configuration screen in the example of FIG. 14 is similar to the case of FIG. 11. In the requirement tracking configuration display screen in the example of FIG. 14, the display area of the system requirement information is similar to that in the case of FIG. 11, and is denoted by the same reference numeral (A11) as that in the case of FIG. 11, and a detailed description thereof is omitted here.

The output device 14 displays, in the display area A22 of the requirement tracking configuration diagram, the system configuration diagram indicating the specific system configuration information satisfying the system requirement input from the input device 13, the requirement tracking configuration diagram indicating the requirement tracking configuration information of the requirement item selected in the display area A11 of the system requirement information, and the design basis information of the display area A23 in an overlapping manner. The design basis information of the display area A23 is design basis information added by the design basis recording unit 815. In the example of FIG. 14, the requirement item “maximum number of users” included in the system requirement information is selected, and in the display area A22, the requirement tracking configuration diagram indicating the requirement tracking configuration information of the requirement item “maximum number of users” is displayed in a highlighted manner on the system configuration diagram indicating the specific system configuration information.

The output device 14 may display, in the display area A22, only the requirement tracking configuration diagram among the requirement tracking configuration diagram and the system configuration diagram. The output device 14 may display, in the display area A22, the requirement tracking configuration diagram and the system configuration diagram side by side.

In the example of FIG. 14, the component “Web App” (web application) included in the requirement tracking configuration diagram is selected. The output device 14 displays, in the display area A23, the attribute related to the requirement item of the selected component "Web App” (web application), the identification name of the selected configuration, and the evaluation content using the attribute for each item of “attribute”, “selected configuration”, and “constraint condition”.

As illustrated in the example of FIG. 14, the output device 14 may display only the design basis information related to the selected component. Alternatively, the output device 14 may display the design basis information related to all the components included in the requirement tracking configuration diagram.

### Description of operation

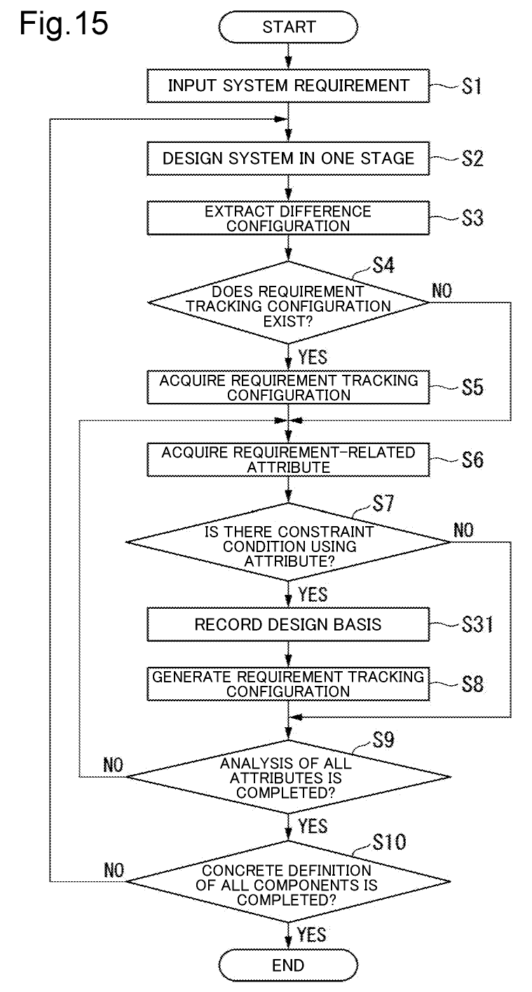

FIG. 15 is a flowchart illustrating an example of an operation of the design system 8. Of the processing steps illustrated in FIG. 15, those similar to the processing steps illustrated in FIG. 7 are denoted by the same reference numerals as in the case of FIG. 7 (S1, S2, S3, S4, S5, S6, S7, S8, S9, S10), and a detailed description thereof will be omitted here.

The processing of FIG. 15 is different from the processing of FIG. 7 in following points.

A first point is that the analysis unit 113 outputs the analysis result information to the design basis recording unit 815 in a case where it is determined that there is a constraint condition using the attribute extracted in step S6 (step S7: YES). Thereafter, the processing proceeds to step S31.

A second point is that the design basis recording unit 815 extracts the design basis information from the constraint condition of the additional component, the constraint condition of the concrete-definition target component, and the constraint condition of the relationship between the additional component and the concrete-definition target component, and adds the extracted design basis information to the analysis result information (step S31). After step S31, the processing proceeds to step S8.

In other respects, the processing of FIG. 15 is similar to the processing of FIG. 7.

### Description of Effect

As described above, the design basis recording unit 815 adds information serving as a basis of design to the requirement tracking configuration information.

The design system 8 outputs the requirement tracking configuration information including the information indicating the design basis, in addition to the information indicating the relationship between the system requirement and the system configuration that is a design result. By referring to the requirement tracking configuration information, the user of the design system 8 can grasp information serving as a detailed basis of how the system requirement is specifically evaluated and the system configuration that is a design result is selected.

### Fourth example embodiment

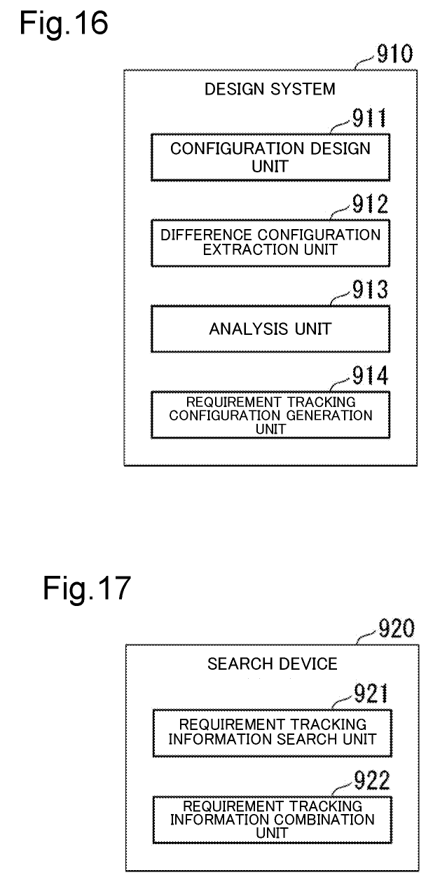

FIG. 16 is a diagram illustrating another example of the configuration of the design system according to at least one example embodiment. As illustrated in FIG. 16, a design system 910 includes a configuration design unit 911, a difference configuration extraction unit 912, an analysis unit 913, and a requirement tracking configuration generation unit 914.

With such a configuration, the configuration design unit 911 receives input of the system requirement, and designs a specific system configuration that satisfies the input system requirement, by repeating concrete definition of the system components constituting the system. The difference configuration extraction unit 912 extracts a system component added or changed in one stage of concrete definition in the design process. The analysis unit 913 determines whether the system component added or changed in one stage of concrete definition is related to the system requirement. The requirement tracking configuration generation unit 914 generates requirement tracking configuration information indicating a relationship between the system requirement and the system configuration, by using a determination result.

The configuration design unit 911 corresponds to an example of the configuration design means. The difference configuration extraction unit 912 corresponds to an example of the difference configuration extraction means. The analysis unit 913 corresponds to an example of the analysis means. The requirement tracking configuration generation unit 914 corresponds to an example of the requirement tracking configuration generation means.

The design system 910 outputs the requirement tracking configuration information indicating the relationship between the system requirement and the system configuration that is a design result. The user of the design system 910 can grasp the relationship between the system requirement and the system configuration that is the design result, by referring to the requirement tracking configuration information.

### Fifth example embodiment

FIG. 17 is a diagram illustrating another example of the configuration of the search device according to at least one example embodiment. As illustrated in FIG. 17, a search device 920 includes a requirement tracking information search unit 921 and a requirement tracking information combination unit 922.

With such a configuration, the requirement tracking information search unit 921 receives the input of the information for identifying the system configuration and the specific system requirement item, and searches for the requirement tracking configuration information of the system requirement item with respect to the system configuration. In a case of receiving a plurality of pieces of the requirement tracking configuration information for one system requirement item, the requirement tracking information combination unit 922 consolidates the plurality of pieces of requirement tracking configuration information into one piece of requirement tracking configuration information.

The requirement tracking information search unit 921 corresponds to an example of the requirement tracking information search means. The requirement tracking information combination unit 922 corresponds to an example of the requirement tracking information combination means.

According to the search device 920, the user of the search device 920 can search for specific requirement tracking configuration information by designating the system configuration and the requirement item. The requirement items may be single or plural, and it is possible to grasp the relationship between the system requirement that the user wants to confirm and the system configuration that is the design result.

### Sixth example embodiment

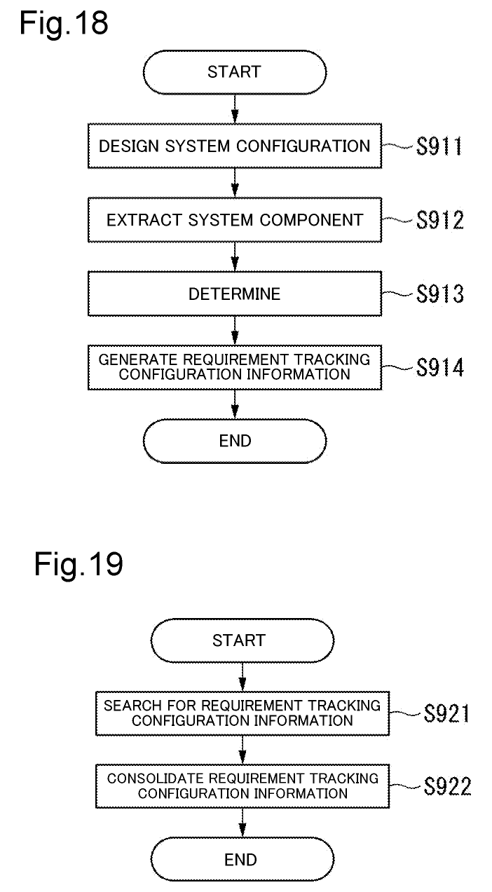

FIG. 18 is a diagram illustrating an example of a procedure of processing in a design method according to at least one example embodiment. The design method illustrated in FIG. 18 includes designing a system configuration (step S911), extracting a system component (step S912), making a determination (step S913), and generating requirement tracking configuration information (step S914).

In designing a system configuration (step S911), a computer receives input of a system requirement and designs a specific system configuration that satisfies the input system requirement, by repeating concrete definition of system components constituting the system.

In extracting a system component (step S912), the computer extracts a system component added or changed in one stage of concrete definition in a design process.

In making a determination (step S913), the computer determines whether the component added or changed in one stage of concrete definition is related to the system requirement.

In generating requirement tracking configuration information (step S914), the computer generates requirement tracking configuration information indicating a relationship between the system requirement and the system configuration, by using a determination result.

According to the design method illustrated in FIG. 18, the computer outputs the requirement tracking configuration information indicating the relationship between the system requirement and the system configuration that is a design result. According to the design method illustrated in FIG. 18, the user of this computer can grasp the relationship between the system requirement and the system configuration that is the design result, by referring to the requirement tracking configuration information.

### Seventh example embodiment

FIG. 19 is a diagram illustrating an example of a procedure of processing in a search method according to at least one example embodiment. The search method illustrated in FIG. 19 includes searching for requirement tracking configuration information (step S921) and consolidating the requirement tracking configuration information (step S922).

In searching requirement tracking configuration information (step S921), the computer receives input of information for identifying a system configuration and a specific system requirement item, and searches for requirement tracking configuration information of the system requirement item with respect to the system configuration.

In consolidating the requirement tracking configuration information (step S922), in a case of detecting a plurality of pieces of the requirement tracking configuration information for one system requirement item, the computer consolidates the plurality of pieces of requirement tracking configuration information into one piece of requirement tracking configuration information.

According to the search method illustrated in FIG. 19, the user of the computer that executes the search method can search for specific requirement tracking configuration information by designating the system configuration and the requirement item. The requirement items may be single or plural, and it is possible to grasp the relationship between the system requirement that the user wants to confirm and the system configuration that is the design result.

In a case where a device or system performs system design, it is preferable that a user can track a system requirement for a completed system configuration.

An object of the present disclosure is to provide a design system, a search device, a design method, a search method, and a program that can solve the above-described problem.

According to the present disclosure, a user can track a system requirement for a completed system configuration.

### Exemplary implementation by software

Some or all of the functions of the design systems 1, 6, 8, and 910 and the search device 920 (hereinafter, also described as “each of the above-described systems or devices”) may be achieved by hardware such as an integrated circuit (IC chip) or may be achieved by software.

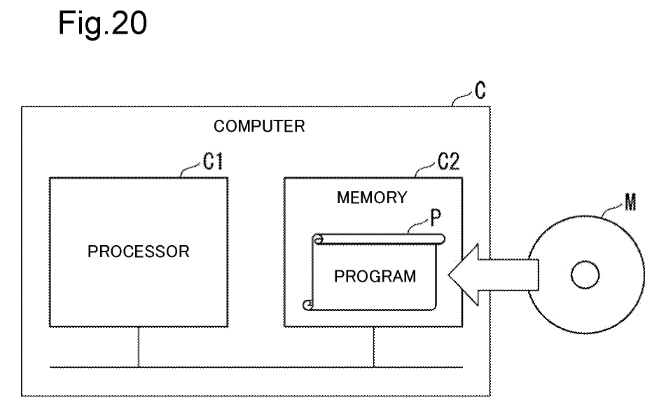

In the latter case, each of the above-described systems or devices is achieved by, for example, a computer that executes a command of a program that is software for achieving each function. An example of such a computer (hereinafter, referred to as a computer C) is illustrated in FIG. 20. FIG. 20 is a block diagram illustrating a hardware configuration of the computer C functioning as each of the above-described devices.

The computer C includes at least one processor C1 and at least one memory C2. A program P for causing the computer C to operate as each of the above-described devices is recorded in the memory C2. In the computer C, by the processor C1 reading the program P from the memory C2 and executing the program P, each function of each of the above-described devices is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P during execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above-described functions of each of the above-described systems or devices may be achieved by a single processor provided in a single computer, may be achieved by a plurality of processors provided in a single computer in cooperation, or may be achieved by a plurality of processors respectively provided in a plurality of computers in cooperation. The program for causing each of the above-described systems or devices to achieve each of the above-described functions may be stored in a single memory provided in a single computer, may be stored in a distributed manner in a plurality of memories provided in a single computer, or may be stored in a distributed manner in a plurality of memories respectively provided in a plurality of computers.

Some or all of the above-described example embodiments may be described as the following Supplementary Notes, but are not limited to the following Supplementary Notes.

### Supplementary Note 1

A design system including:

a configuration design means for receiving input of a system requirement; and designing a specific system configuration that satisfies the input system requirement, by a process of repeating concrete definition of system components constituting a system;

a difference configuration extraction means for extracting a system component added or changed in one stage of concrete definition in a design process;

an analysis means for determining whether the system component added or changed in one stage of concrete definition is related to the system requirement; and

a requirement tracking configuration generation means for generating requirement tracking configuration information indicating a relationship between the system requirement and the system configuration, by using a determination result.

### Supplementary Note 2

The design system according to supplementary note 1, further including:

a requirement tracking information search means for receiving input of information for identifying a system configuration and a specific system requirement item and searching for requirement tracking configuration information of the system requirement item with respect to the system configuration; and

a requirement tracking information combination means for, in a case of receiving a plurality of pieces of the requirement tracking configuration information for one system requirement item, consolidating the plurality of pieces of requirement tracking configuration information into one piece of requirement tracking configuration information.

### Supplementary Note 3

The design system according to supplementary note 1 or 2, further including: a design basis recording means for adding information serving as a basis of design to the requirement tracking configuration information.

### Supplementary Note 4

A search device including:

a requirement tracking information search means for receiving input of information for identifying a system configuration and a specific system requirement item and searching for requirement tracking configuration information of the system requirement item with respect to the system configuration; and

a requirement tracking information combination means for, in a case of receiving a plurality of pieces of the requirement tracking configuration information for one system requirement item, consolidating the plurality of pieces of requirement tracking configuration information into one piece of requirement tracking configuration information.

### Supplementary Note 5

A design method including:

a step of a computer receiving input of a system requirement; and designing a specific system configuration that satisfies the input system requirement, by a process of repeating concrete definition of system components constituting a system;

a step of the computer extracting a system component added or changed in one stage of concrete definition in a design process;

a step of the computer determining whether the component added or changed in one stage of concrete definition is related to the system requirement; and

a step of the computer generating requirement tracking configuration information indicating a relationship between the system requirement and the system configuration, by using a determination result.

### Supplementary Note 6

The design method according to supplementary note 5, further including:

a step of the computer receiving input of information for identifying a system configuration and a specific system requirement item and searching for requirement tracking configuration information of the system requirement item with respect to the system configuration; and

a step of, in a case of receiving a plurality of pieces of the requirement tracking configuration information for one system requirement item, the computer consolidating the plurality of pieces of requirement tracking configuration information into one piece of requirement tracking configuration information.

### Supplementary Note 7

The design method according to supplementary note 5 or 6, further including:

a step of the computer adding information serving as a basis of design to the requirement tracking configuration information.

### Supplementary Note 8

A search method including:

a step of a computer receiving input of information for identifying a system configuration and a specific system requirement item and searching for requirement tracking configuration information of the system requirement item with respect to the system configuration; and

a step of, in a case of detecting a plurality of pieces of the requirement tracking configuration information for one system requirement item, the computer consolidating the plurality of pieces of requirement tracking configuration information into one piece of requirement tracking configuration information.

### Supplementary Note 9

A program that causes a computer to execute:

processing of receiving input of a system requirement; and designing a specific system configuration that satisfies the input system requirement, by a process of repeating concrete definition of system components constituting a system;

processing of extracting a system component added or changed in one stage of concrete definition in a design process;

processing of determining whether the system component added or changed in one stage of concrete definition is related to the system requirement; and

processing of generating requirement tracking configuration information indicating a relationship between the system requirement and the system configuration, by using a determination result.

### Supplementary Note 10

The program according to supplementary note 9 that causes the computer to further execute:

processing of receiving input of information for identifying a system configuration and a specific system requirement item and searching for requirement tracking configuration information of the system requirement item with respect to the system configuration; and

processing of, in a case of receiving a plurality of pieces of the requirement tracking configuration information for one system requirement item, consolidating the plurality of pieces of requirement tracking configuration information into one piece of requirement tracking configuration information.

### Supplementary Note 11

The program according to supplementary note 9 or 10 that causes the computer to further execute:

processing of adding information serving as a basis of design to the requirement tracking configuration information.

### Supplementary Note 12

A program that causes a computer to execute:

processing of receiving input of information for identifying a system configuration and a specific system requirement item and searching for requirement tracking configuration information of the system requirement item with respect to the system configuration; and

processing of, in a case of detecting a plurality of pieces of the requirement tracking configuration information for one system requirement item, consolidating the plurality of pieces of requirement tracking configuration information into one piece of requirement tracking configuration information.

1. A design system comprising:
a memory; and
at least one processor coupled to the memory,
the at least one processor performing operations to:
receive input of a system requirement; and design a specific system configuration that satisfies the input system requirement, by a process of repeating concrete definition of system components constituting a system;
extract a system component added or changed in one stage of concrete definition in a design process;
determine whether the system component added or changed in one stage of concrete definition is related to the system requirement; and
generate requirement tracking configuration information indicating a relationship between the system requirement and the system configuration, by using a determination result.

2. The design system according to claim 1, wherein
the at least one processor performing operations to:
receive input of information for identifying a system configuration and a specific system requirement item and search for requirement tracking configuration information of the system requirement item with respect to the system configuration; and
in a case of receiving a plurality of pieces of the requirement tracking configuration information for one system requirement item, consolidate the plurality of pieces of requirement tracking configuration information into one piece of requirement tracking configuration information.

3. The design system according to claim 1, wherein
the at least one processor performing operations to:
add information serving as a basis of design to the requirement tracking configuration information.

4. A design method performed by a computer, the method comprising:
receiving input of a system requirement; and designing a specific system configuration that satisfies the input system requirement, by a process of repeating concrete definition of system components constituting a system;
extracting a system component added or changed in one stage of concrete definition in a design process;
determining whether the component added or changed in one stage of concrete definition is related to the system requirement; and
generating requirement tracking configuration information indicating a relationship between the system requirement and the system configuration, by using a determination result.

5. The design method according to claim 4, further comprising:
receiving input of information for identifying a system configuration and a specific system requirement item and searching for requirement tracking configuration information of the system requirement item with respect to the system configuration; and
in a case of receiving a plurality of pieces of the requirement tracking configuration information for one system requirement item, the computer consolidating the plurality of pieces of requirement tracking configuration information into one piece of requirement tracking configuration information.

6. The design method according to claim 4, further comprising:
a step of the computer adding information serving as a basis of design to the requirement tracking configuration information.

7. A non-transitory computer-readable storage medium storing a program that, when executed by a computer, causes the computer to perform a process comprising:
receiving input of a system requirement; and designing a specific system configuration that satisfies the input system requirement, by a process of repeating concrete definition of system components constituting a system;
extracting a system component added or changed in one stage of concrete definition in a design process;
determining whether the system component added or changed in one stage of concrete definition is related to the system requirement; and
generating requirement tracking configuration information indicating a relationship between the system requirement and the system configuration, by using a determination result.

8. The non-transitory computer-readable storage medium according to claim 7, wherein the process further comprises:
receiving input of information for identifying a system configuration and a specific system requirement item and searching for requirement tracking configuration information of the system requirement item with respect to the system configuration; and
in a case of receiving a plurality of pieces of the requirement tracking configuration information for one system requirement item, consolidating the plurality of pieces of requirement tracking configuration information into one piece of requirement tracking configuration information.

9. The non-transitory computer-readable storage medium according to claim 7, wherein the process further comprises:
adding information serving as a basis of design to the requirement tracking configuration information.
